(19) United States
(12) Patent Application Publication
(10) Pub. No.: US 2013/0289189 A1
(43) Pub. Date: Oct. 31, 2013

(54) Thermoprocessable per(halo)fluoropolymer composition

(71) Applicants: Pasqua Colaianna, Milano (IT); Marco Avataneo, Senago, Milano (IT); Emanuele Di Nicolo, Paderno Dugnano (MI) (IT); Giambattista Besana, Mariano Comense (CO) (IT); Giuseppe Marchionni, Milano (IT)

(72) Inventors: Pasqua Colaianna, Milano (IT); Marco Avataneo, Senago, Milano (IT); Emanuele Di Nicolo, Paderno Dugnano (MI) (IT); Giambattista Besana, Mariano Comense (CO) (IT); Giuseppe Marchionni, Milano (IT)

(73) Assignee: SOLVAY SPECIALTY POLYMERS ITALY S.P.A., Bollate MI (IT)

(21) Appl. No.: 13/993,941

(22) PCT Filed: Dec. 16, 2011
(86) PCT No.: PCT/EP2011/073146

§ 371 Date: Jun. 13, 2013

(30) Foreign Application Priority Data
Dec. 20, 2010 (EP) 10196005.2

(51) Int. Cl. C08L 53/00

(52) U.S. Cl. CPC C08L 53/00
USPC 524/423; 524/505

(57) ABSTRACT

The invention pertains to a thermoprocessable composition comprising:
at least one thermoprocessable per(halo)fluoropolymer [polymer (A)];
at least one inorganic filler [filler (I)]; and
at least one perfluoropolyether block copolymer [polymer (E)] comprising:
A) one or more (per)fluoropolyoxyalkylene segment (chain R_{f}), that is to say a segment comprising recurring units having at least one catenary ether bond and at least one fluorocarbon moiety, and
B) one or more polyalkylene segment (chain Rₐ) comprising recurring units of formula: —(CR₁R₂—CR₃R₄)—
   wherein R₁, R₂, R₃, R₄, equal to or different from each other, are selected from the group consisting of H, halogens (preferably F, Cl); C₁-C₆ (hydro)carbon groups, optionally containing fluorine or other heteroatoms, preferably perfluoroalkyl or (per)fluorooxyalkyl.

This application claims priority to European application EP 10196005.2 filed on Dec. 20, 2011, the whole content of this application being incorporated herein by reference for all purposes.

### TECHNICAL FIELD

The invention pertains to thermoprocessable per(halo)fluoropolymer compositions comprising inorganic fillers and containing certain perfluoropolyether additives enabling substantial improvement of dispersability of the filler, processability behaviour and final mechanical properties.

### BACKGROUND ART

Thermoprocessable per(halo)fluoropolymers, including notably copolymers of tetrafluoroethylene with perfluoroalkylvinylethers or perfluoroolefins (e.g. hexafluoropropylene) are materials of choice in high end applications, including notably cable sheathing, coating and components in the chemical industry, wherein resistance in extremely harsh environment (exposure to chemicals, high temperatures . . . ) is required.

It is also often required, in order to match requirements for final end use applications (e.g. antistatic/conductive properties, barrier properties, improved mechanical properties . . . ), to add to said per(halo)fluoropolymer matrices certain inorganic fillers, including, notably, inorganic oxides, carbon black, in amounts which can exceed several percents.

Nevertheless, dispersing inorganic fillers in said thermoprocessable per(halo)fluoropolymer, in particular in devices operating in the molten state is not an easy task and extreme conditions are sometimes required for achieving adequate fillers dispersion. Further, in addition, thermoprocessable per(halo)fluoropolymer compositions comprising said fillers may thus face processability problems when manufacturing final parts e.g. by extrusion moulding, the presence of such fillers, especially at high concentration, possibly having a detrimental effect on melt flow behaviour in said processing devices.

Traditionally, these issues are solved by addition of processing additives; nevertheless, in the case of per(halo)fluoropolymers, traditional additives hardly withstand processability conditions (temperatures often exceeding 300° C.) and discolouring or degradation phenomena might be caused in final parts. Further, in addition, mechanical properties of the so obtained filled material can be in certain cases negatively affected by the presence of such additives.

This having said, it is worth mentioning that document WO 2008/065164 (SOLVAY SOLEXIS S.P.A.) May 6, 2008 discloses compositions comprising thermoprocessable semicrystalline halopolymers and certain block copolymers comprising a PFPE block and a further block derived from polyaddition polymerization of ethylenically unsaturated monomers, e.g. tetrafluoroethylene. Nevertheless, such block copolymers are merely used as lubricating additives in bare halopolymers, in particular in vinylidene fluoride polymer or in ethylene-chlorotrifluoroethylene copolymers. Nowhere in this document, is mention made of the suitability of these additives for improving dispersability of fillers in halopolymers.

There is thus a current shortfall in the art for suitable additives for thermoprocessable per(halo)fluoropolymers enabling outstanding dispersion of inorganic fillers while maintaining or even improving processability in the molten state and mechanical properties in final moulded parts.

### SUMMARY OF INVENTION

The invention thus provides for a thermoprocessable composition comprising:
at least one thermoprocessable per(halo)fluoropolymer [polymer (A)];
at least one inorganic filler [filler (I)]; and
at least one perfluoropolyether block copolymer [polymer (E)] comprising:
   A) one or more (per)fluoropolyoxyalkylene segment (chain R_{f}), that is to say a segment comprising recurring units having at least one catenary ether bond and at least one fluorocarbon moiety, and
   B) one or more polyalkylene segment (chain Rₐ) comprising recurring units of formula: —(CR₁, R₂—CR₃R₄)—
   wherein R₁, R₂, R₃, R₄, equal to or different from each other, are selected from the group consisting of H, halogens (preferably F, Cl); C₁-C₆ (hydro)carbon groups, optionally containing fluorine or other heteroatoms, preferably perfluoroalkyl or (per)fluorooxyalkyl.

The Applicant has surprisingly found that by means of the addition of the perfluoropolyether block copolymer as detailed above, it is advantageously possible to obtain a composition based on a per(halo)fluoropolymer which can be easily processed in the molten state even in the presence of substantial amounts of inorganic fillers, without undergoing any discolouring or degradation phenomena, like those usually encountered when using processing aid of low stability.

The (per)fluoropolyoxyalkylene segment (chain R_{f}) of polymer (E) is preferably a chain comprising recurring units (R₁), said recurring units having general formula: —(CF₂)ₖ—CFZ—O—, wherein k is an integer of from 0 to 3 and Z is selected between a fluorine atom and a C₁-C₆ perfluoro(oxy)alkyl group.

Chain R_{f} more preferably complies with formula:

—(CF₂CF₂O)_{a′}(CFYO)_{b′}(CF₂CFYO)_{c′}(CF₂O)_{d′}(CF₂(CF₂)_{z}CF₂O)_{e′}—,
the recurring units being statistically distributed along the (per)fluoropolyoxyalkylene chain, wherein:
Y is a C₁-C₅ perfluoro(oxy)alkyl group;
z is 1 or 2;
a′, b′, c′, d′, e′ are integers ≧0.

Most preferably, chain R_{f} complies with formula:

—(CF₂CF₂O)_{a″}(CF₂O)_{b″}(CF₂(CF₂)_{z}CF₂O)_{c″}—, wherein:
z is 1 or 2;
a″, b″, c″ are integers 0.

Polymer (E) typically complies with formula:

Tₗ-O-[A-B]_{z}-[A-B′]_{z′}-A-T_{l′} (formula I)

wherein:
A=-(X)ₐ—O-A′-(X′)_{b}—, wherein A′ is a chain R_{f}, as above detailed; X, X′, equal to or different from each other, are selected from —CF₂—, —CF₂CF₂—, —CF(CF₃)—; a, b, equal to or different from each other, are integers equal to 0 or 1, with the proviso that the block A linked to the end group Tₗ-O— has a=1 and the block A linked to the end group T′ₗ has b=0;
B is a segment of recurring units derived from one or more olefins having formula:

—[(CR₁R₂—CR₃R₄)ⱼ(CR₅R₆—CR₇R₈)_{j′}]— (formula Ia),

wherein: j is an integer from 1 to 100, j′ is an integer from 0 to 100 with the proviso that (j+j′) is higher than 2 and lower than 100; R₁, R₂, R₃, R₄, R₅, R₆, R₇, R₉, equal to or different from each other, are selected from halogen (preferably F, Cl); H; C₁-C₆ groups, optionally containing F or other heteroatoms, preferably perfluoroalkyl or (per)fluorooxyalkyl, said substituents R₁-R₈ optionally containing one or more functional groups;
z is an integer higher than or equal to 2; z′ is ≧0; z, z′ are such that the number average molecular weight of the polymer (F) of formula (I) is in the range 500-500,000;
B′ is a segment otherwise complying with formula (Ia), but having at least one of the substituents R₁ to R₈ different than those in block B;
Tₗ and Tₗ′, equal to or different from each other, are selected from H, halogen, C₁₋₃ (per)fluoroalkyls, C₁₋₆ alkyls and C₁-C₃₀ functional end groups comprising heteroatoms chosen among O, S, N.

Said products can be produced by reacting (per)fluoropolyethers comprising peroxide groups with (fluoro)olefins, as detailed in patent application WO 2008/065163 (SOLVAY SOLEXIS S.P.A.) May 6, 2008 and WO 2008/065165 (SOLVAY SOLEXIS S.P.A.).

Preferably, Tₗ and Tₗ′, equal to or different from each other, are selected from the group consisting of:

(j) —Y′, wherein Y′ is chain end chosen among —H, halogen, such as —F, —C₁, C₁-C₃ perhalogenated alkyl group, such as —CF₃, —C₂F₅, —CF₂Cl, —CF₂CF₂Cl,
(jj) -Eᵣ-A_{q}-Y″ₖ, wherein k, r and q are integers, with q=0 or 1, r=0 or 1, and k between 1 and 4, preferably between 1 and 2, E denotes a functional linking group comprising at least one heteroatom chosen among O, S, N; A denotes a C₁-C₂₀ bivalent linking group; and Y″ denotes a functional end-group.

The functional group E may comprise an amide, ester, carboxylic, thiocarboxylic, ether, heteroaromatic, sulfide, amine, and/or imine group.

Non limitative examples of functional linking groups E are notably —CONR— (R=H, C₁-C₁₅ substituted or unsubstituted linear or cyclic aliphatic group, C₁-C₁₅ substituted or unsubstituted aromatic group); —COO—; —COS—; —CO—; an heteroatom such as —O—; —S—; —NR′—(R=H, C₁-C₁₅ substituted or unsubstituted linear or cyclic aliphatic group, C₁-C₁₅ substituted or unsubstituted aromatic group); a 5- or 6-membered aromatic heterocycle containing one or more heteroatoms chosen among N, O, S, the same or different each other, in particular triazines, such as

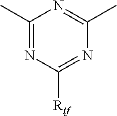

with R_{tf} being a perfluoroalkyl group, e.g. —CF₃.

The bivalent C₁-C₂₀ linking group A is preferably selected from the following classes:
1. linear substituted or unsubstituted C₁-C₂₀ alkylenic chain, optionally containing heteroatoms in the alkylenic chain; preferably linear aliphatic group comprising moieties of formula —(CH₂)ₘ—, with m integer between 1 and 20, and optionally comprising amide, ester, ether, sulfide, imine groups and mixtures thereof;
2. (alkylene)cycloaliphatic C₁-C₂₀ groups or (alkylen)aromatic C₁-C₂₀ groups, optionally containing heteroatoms in the alkylenic chain or in the ring, and optionally comprising amide, ester, ether, sulfide, imine groups and mixtures thereof;
3. linear or branched polyalkylenoxy chains, comprising in particular repeating units selected from: —CH₂CH₂O—, —CH₂CH(CH₃)O—, —(CH₂)₃O—, —(CH₂)₄O—, optionally comprising amide, ester, ether, sulfide, imine groups and mixtures thereof.

Examples of suitable functional groups Y″ are notably —OH, —SH, —OR′, —SR′, —NH₂, —NHR′, —NR′₂, —COOH, —SiR′_{d}Q_{3-d}, —CN, —NCO, epoxy group —(C₂H₃O—), 1,2- and 1,3-diols as such or as cyclic acetals and ketals (e.g., dioxolanes or dioxanes), —COR′, —CH(OCH₃)₂, —CH(OH)CH₂OH, —CH(COOH)₂, —CH(COOR′)₂, —CH(CH₂OH)₂, —CH(CH₂NH₂)₂, —PO(OH)₂, —CH(CN)₂, wherein R′ is an alkyl, cycloaliphatic or aromatic substituted or unsubstituted group, optionally comprising one or more fluorine atoms, Q is OR′, R′ having the same meaning as above defined, d is an integer between 0 and 3.

One or more functional end-groups Y″ can be linked to the group A and/or E: for instance, when A is an (alkylen)aromatic C₁-C₂₀ group, it is possible that two or more Y″ groups are linked to the aromatic ring of the group A.

More preferably, the polymer (E) complies with formula (I) here above, wherein Tₗ and Tₗ′, equal to or different from each other, are selected from the group consisting of: —H; halogen such as —F and —Cl; C₁-C₃ perhalogenated alkyl group, such as —CF₃, —C₂F₅, —CF₂Cl, —CF₂CF₂Cl; —CH 20H; —CH₂(OCH₂CH₂)ₙOH (n being an integer between 1 and 3); —C(O)OH; —C(O)OCH₃; —CONH—R_{H}—OSi(OC₂H₅)₃ (where R_{H} is a C₁-C₁₀ alkyl group); —CONHC₁₈H₃₇; —CH₂OCH₂CH(OH)CH₂OH; —CH₂—O—(CH₂CH₂O)ₙ*PO(OH)₂ (with n* between 1 and 3); and mixtures thereof.

In formula I here above, block B derives from one or more olefins polymerizable by radical route; among those olefins mention can be made of tetrafluoethylene (TFE), ethylene (E), vinylidene fluoride (VDF), chlorotrifluoroethylene (CTFE), hexafluoropropylene (HFP), (per)fluoroalkylvinylethers, (per)fluoroalkoxyalkylvinylethers.

Similarly, block B′ derives from one or more olefins polymerizable by radical route, at least one of which is different from olefin(s) of block B. Olefins as above indicated for block B are suitable for being used for block B′.

It is generally preferred that block B and B′ (when this latter is present) comprise recurring units derived from perfluorinated olefins.

Particularly preferred to the purpose of the invention is a polymer (E) complying with formula (I) here above, wherein z′ is zero, j′ is zero and each of R₁, R₂, R₃, R₄ are fluorine atoms, that is to say, wherein block B is derived from tetrafluoethylene and block B′ is absent.

Thus, most preferred polymer (E) complies with formula:

Tₗ-O-[A-B]_{z}-A-Tₗ′ (formula II)

wherein:
A=-(X)ₐ—O-A′-(X′)_{b}—, wherein X, a and b have the meanings above defined and A′ is a chain R_{f} of formula:

—(CF₂CF₂O)ₐ₊(CF₂O)_{b+}(CF₂(CF₂)_{z+}CF₂O)_{c+}—,

wherein: z⁺ is 1 or 2; a+, b+, c+ are integers ≧0;
B is a segment of formula —[(CF₂—CF₂)ⱼ₊]— wherein: j+ is an integer from 2 to 100;
Tₗ and Tₗ′, equal to or different from each other, are selected from the group consisting of: —H; halogen such as —F and —Cl; C₁-C₃ perhalogenated alkyl group, such as —CF₃, —C₂F₅, —CF₂Cl, —CF₂CF₂Cl.

For the purpose of the invention, the term “per(halo)fluoropolymer” is intended to denote a fluoropolymer substantially free of hydrogen atoms.

The per(halo)fluoropolymer can comprise one or more halogen atoms (Cl, Br, I), different from fluorine.

The term “substantially free of hydrogen atom” is understood to mean that the per(halo)fluoropolymer consists essentially of recurring units derived from ethylenically unsaturated monomers comprising at least one fluorine atom and free of hydrogen atoms [per(halo)fluoromonomer (PFM)].

The per(halo)fluoropolymer can be a homopolymer of a per(halo)fluoromonomer (PFM) or a copolymer comprising recurring units derived from more than one per(halo)fluoromonomer (PFM).

Non limitative examples of suitable per(halo)fluoromonomers (PFM) are notably:
C₂-C₈ perfluoroolefins, such as tetrafluoroethylene (TFE) and hexafluoropropene (HFP);
chloro- and/or bromo- and/or iodo-C₂-C₆ per(halo)fluoroolefins, like chlorotrifluoroethylene;
per(halo)fluoroalkylvinylethers complying with general formula CF₂═CFOR_{f1} in which R_{f1} is a C₁-C₆ per(halo)fluoroalkyl, such as —CF₃, —C₂ F₅, —C₃F₇;
per(halo)fluoro-oxyalkylvinylethers complying with general formula CF₂═CFOX₀₁, in which X₀₁ is a C₁-C₁₂ per(halo)fluorooxyalkyl having one or more ether groups, like perfluoro-2-propoxy-propyl group;
per(halo)fluoro-methoxy-alkylvinylethers complying with general formula CF₂═CFOCF₂OR_{f2} in which R_{f2} is a C₁-C₆ per(halo)fluoroalkyl, such as —CF₃, —C₂F₅, —C₃F₇ or a C₁-C₆ per(halo)fluorooxyalkyl having one or more ether groups, such as —C₂F₅—O—CF₃;
per(halo)fluorodioxoles of formula:

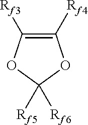

wherein each of R_{f3}, R_{f4}, R_{f5}, R_{f6}, equal of different each other, is independently a fluorine atom, a C₁-C₆ perfluoroalkyl group, optionally comprising one or more oxygen atom, e.g. —CF₃, —C₂F₅, —C₃F₇, —OCF₃, —OCF₂CF₂OCF₃; preferably a per(halo)fluorodioxole complying with formula here above, wherein R_{f3} and R_{f4} are fluorine atoms and R_{f5} and R_{f6} are perfluoromethyl groups (—CF₃)
[perfluoro-2,2-dimethyl-1,3-dioxole (PDD)], or a per(halo)fluorodioxole complying with formula here above, wherein R_{f3}, R_{f5} and R_{f6} are fluorine atoms and R_{f4} is a perfluoromethoxy group (—OCF₃) [2,2,4-trifluoro-5-trifluoromethoxy-1,3-dioxole or perfluoromethoxydioxole (MDO)].

The per(halo)fluoropolymer is advantageously chosen among copolymers of tetrafluoroethylene (TFE) with at least one per(halo)fluoromonomer (PFM) different from TFE.

The TFE copolymers as above detailed comprise advantageously at least 1.5% wt, preferably at least 5% wt, more preferably at least 7% wt of recurring units derived from the per(halo)fluoromonomer (PFM).

The TFE copolymers as above detailed comprise advantageously at most 30% wt, preferably at most 25% wt, more preferably 20% wt of recurring units derived from the per(halo)fluoromonomer (PFM).

Good results have been obtained with TFE copolymers as above detailed comprising at least 2% wt and at most 30% wt of recurring units derived from the per(halo)fluoromonomer (PFM).

Preferred per(halo)fluoropolymers [polymers (A)] are selected among TFE copolymers comprising recurring units derived from at least one per(halo)fluoromonomer (PFM) chosen among the group consisting of:
1. perfluoroalkylvinylethers complying with formula CF₂═CFOR_{f1′}, in which R_{f1′} is a C₁-C₆ perfluoroalkyl, e.g. —CF₃, —C₂F₅, —C₃F₇; and/or
2. perfluoro-oxyalkylvinylethers complying with general formula CF₂═CFOX₀, in which X₀ is a C₁-C₁₂ perfluorooxyalkyl having one or more ether groups, like perfluoro-2-propoxy-propyl group; and/or
3. C₃-C₈ perfluoroolefins, such as hexafluoropropene (HFP); and/or
4. perfluorodioxoles of formula:

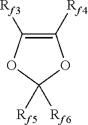

wherein each of R_{f3}, R_{f4}, R_{f5}, R_{f6}, equal of different each other, is independently a fluorine atom, a C₁-C₆ perfluoroalkyl group, optionally comprising one or more oxygen atom, e.g. —CF₃, —C₂F₅, —C₃F₇, —OCF₃, —OCF₂CF₂OCF₃.

More preferred per(halo)fluoropolymers are selected among TFE copolymers comprising recurring units derived from at least one per(halo)fluoromonomer (PFM) chosen among the group consisting of:
1. perfluoroalkylvinylethers complying with general formula CF₂═CFOR_{f1} in which R_{f1} is a C₁-C₆ perfluoroalkyl;
2. perfluoro-oxyalkylvinylethers complying with general formula CF₂═CFOX₀₁, in which X₀₁ is a C₁-C₁₂ perfluorooxyalkyl having one or more ether groups;
3. C₃-C₈ perfluoroolefins; and
4. mixtures thereof.

According to a first embodiment of the invention, the polymer (A) is chosen among TFE copolymers comprising recurring units derived from HFP and optionally from at least one per(halo)fluoroalkylvinylether, as above defined, preferably from at least one perfluoroalkylvinylether complying with general formula CF₂═CFOR_{f1′} in which R_{f1′} is a C₁-C₆ perfluoroalkyl.

Preferred polymers (A) according to this embodiment are selected among TFE copolymers comprising (preferably consisting essentially of) recurring units derived from tetrafluoroethylene (TFE) and hexafluoropropylene (HFP) in an amount ranging from 3 to 15 wt % and, optionally, from 0.5 to 3 wt % of at least one perfluoroalkylvinylether, as above defined.

The expression ‘consisting essentially of’ is used within the context of the present invention for defining constituents of a polymer to take into account end chains, defects, irregularities and monomer rearrangements which might be comprised in said polymers in minor amounts, without this modifying essential properties of the polymer.

A description of such polymers (A) can be found notably in U.S. Pat. No. 4,029,868 (DU PONT) Jun. 14, 1977, in U.S. Pat. No. 5,677,404 (DU PONT) Oct. 14, 1997, in U.S. Pat. No. 5,703,185 (DU PONT) Dec. 30, 1997, and in U.S. Pat. No. 5,688,885 (DU PONT) Nov. 18, 1997.

Polymer (A) according to this embodiment are commercially available under the trademark TEFLON® FEP 9494, 6100 and 5100 from E.I. DuPont de Nemours, or from Daikin (e.g. FEP NP-101 material), or from Dyneon LLC (FEP 6322).

Best results within this embodiment have been obtained with TFE copolymers comprising (preferably consisting essentially of) recurring units derived from tetrafluoroethylene (TFE) and hexafluoropropylene (HFP) in an amount ranging from 4 to 12 wt % and either perfluoro(ethyl vinyl ether) or perfluoro(propyl vinyl ether) in an amount from 0.5 to 3% wt.

According to a second embodiment of the invention, the polymer (A) is chosen among TFE copolymers comprising recurring units derived from at least one per(halo)fluoroalkylvinylether, as above defined, preferably from at least one perfluoroalkylvinylether, as above defined and optionally further comprising recurring units derived from C₃-C₈ perfluoroolefins.

Good results within this second embodiment have been obtained with TFE copolymers comprising recurring units derived from one or more than one perfluoroalkylvinylether as above specified; particularly good results have been achieved with TFE copolymers wherein the perfluoroalkylvinylether is perfluoromethylvinylether (of formula CF₂═CFOCF₃), perfluoroethylvinylether (of formula CF₂═CFOC₂F₅), perfluoropropylvinylether (of formula CF₂═CFOC₃F₇) and mixtures thereof.

According to a preferred variant of the second embodiment of the invention, the polymer (A) is advantageously a TFE copolymer consisting essentially of:

(a) from 3 to 13%, preferably from 5 to 12% by weight of recurring units derived from perfluoromethylvinylether;
(b) from 0 to 6% by weight of recurring units derived from one or more than one fluorinated comonomer different from perfluoromethylvinylether and selected from the group consisting of perfluoroalkylvinylethers complying with general formula CF₂═CFOR_{f1′} in which R_{f1′} is a C₁-C₆ perfluoroalkyl and perfluoro-oxyalkylvinylethers complying with general formula CF₂═CFOX₀₁′, in which X_{01′} is a C₁-C₁₂ perfluorooxyalkyl having one or more ether groups; preferably derived from perfluoroethylvinylether and/or perfluoropropylvinylether;
(c) recurring units derived from tetrafluoroethylene, in such an amount that the sum of the percentages of the recurring units (a), (b) and (c) is equal to 100% by weight.

MFA and PFA suitable to be used for the composition of the invention are commercially available from Solvay Solexis Inc. under the trade name of HYFLON® PFA P and M series and HYFLON® MFA.

According to another preferred variant of this second embodiment of the invention, the polymer (A) is advantageously a TFE copolymer consisting essentially of:

(a) from 0.5 to 5% by weight of recurring units derived from perfluoromethylvinylether;
(b) from 0.4 to 4.5% by weight of recurring units derived from one or more than one fluorinated comonomer different from perfluoromethylvinylether and selected from the group consisting of perfluoroalkylvinylethers, as above detailed and/or perfluoro-oxyalkylvinylethers, as above detailed; preferably derived from perfluoroethylvinylether and/or perfluoropropylvinylether;
(c) from 0.5 to 6% weight of recurring units derived from at least one C₃-C₈ perfluoroolefins, preferably derived from hexafluoropropylene; and
(d) recurring units derived from tetrafluoroethylene, in such an amount that the sum of the percentages of the recurring units (a), (b), (c) and (d) is equal to 100% by weight.

For the purpose of the present invention, by the term “thermoprocessible” is meant that the polymer (A) can be processed (i.e. fabricated into shaped articles such as films, fibers, tubes, fittings, wire coatings and the like) by conventional melt extruding, injecting or casting means by the action of the temperature. This generally requires that the melt viscosity at the processing temperature be no more than 10⁸ Pa×sec, preferably from 10 to 10⁸ Pa×sec.

Thus, polymer (A) is distinguishable from “non thermoprocessible” fluoropolymers, like notably PTFE, which cannot be processed by conventional melt extruding, injecting or casting means, and which generally exhibit a melt viscosity at the processing temperature exceeding 10⁸ Pa×sec.

The melt viscosity of the polymer (A) can be measured according to ASTM D-1238, using a cylinder, orifice and piston tip made of a corrosion-resistant alloy, charging a sample to the 9.5 mm inside diameter cylinder which is maintained at a temperature exceeding melting point, extruding the sample through a 2.10 mm diameter, 8.00 mm long square-edged orifice under a load (piston plus weight) of 5 kg. Melt viscosity is calculated in Pa×sec from the observable extrusion rate in grams per minute.

Also, polymer (A) typically has a dynamic viscosity at a shear rate of 1 rad×sec⁻¹ and at a temperature exceeding melting point of about 30° C., preferably at a temperature of Tₘ₂+(30±2° C.) is comprised between 10 and 10⁶ Pa×sec, when measured with a controlled strain rheometer, employing an actuator to apply a deforming strain to the sample and a separate transducer to measure the resultant stress developed within the sample, and using the parallel plate fixture.

The polymer (A) of the invention is advantageously thermoplastic.

The term “thermoplastic” is understood to mean, for the purposes of the present invention, polymers existing, at room temperature (25° C.), below their melting point if they are semi-crystalline, or below their T_{g} if amorphous. These polymers have the property of becoming soft when they are heated and of becoming rigid again when hey are cooled, without there being an appreciable chemical change. Such a definition may be found, for example, in the encyclopaedia called “Polymer Science Dictionary”, Mark S. M. Alger, London School of Polymer Technology, Polytechnic of North London, UK, published by Elsevier Applied Science, 1989.

Preferably, the polymer (A) is semi-crystalline.

The term “semi-crystalline” is intended to denote a polymer having a heat of fusion of more than 1 J/g when measured by Differential Scanning calorimetry (DSC) at a heating rate of 10° C./min, according to ASTM D 3418.

Preferably, the semi-crystalline polymer (A) of the invention has a heat of fusion of at least 3 J/g, more preferably of at least 5 J/g, most preferably at least 10 J/g.

The choice of the inorganic filler is not particularly critical and will be done by the skilled in the art as a function of the property which is required in the host per(halo)fluoropolymer; it is generally understood that inorganic fillers which remain inert during polymer (A) processing and use are preferred. Non limitative examples of inorganic fillers which can be used are notably carbonaceous materials, metal oxides, metal carbonates, metal sulphates, carbides and the like.

Carbonaceous materials are commonly used additives and fillers which exhibit interesting structural, mechanical, electrical and electromechanical properties and which have found use in per(halo)fluoropolymers e.g. for conferring antistatic properties and/or as reinforcement fillers.

Within the context of the present invention, the expression “carbonaceous material” is intended to denote all those materials which essentially consist of carbon. It is understood that said carbonaceous materials might comprise reduced amounts of other elements (e.g. H, O, N, S . . . ), without this significantly affecting the physico-chemical properties of the carbonaceous material itself.

Among carbonaceous materials suitable for the purposes of the invention, mention can be notably made of carbon black, carbon fibers, diamond like carbon, graphite, fullerenes, including spherical fullerenes and carbon nanotubes.

Preferably the carbonaceous material is carbon black. The expression “carbon black” is intended to denote powdered form of highly dispersed, amorphous elemental carbon. Carbon black is generally available as a finely divided, colloidal material in the form of spheres and their fused aggregates. Types of carbon black are characterized by the size distribution of the primary particles, and the degree of their aggregation and agglomeration. Average primary particle diameters of carbon black typically range from 10 to 400 nm, while average aggregate diameters range from 100 to 800 nm. Carbon black can be manufactured under controlled conditions whereas soot is randomly formed, and they can be distinguished on the basis of tar, ash content and impurities. Carbon black can be also made by the controlled vapor-phase pyrolysis and/or thermal cracking of hydrocarbon mixtures such as heavy petroleum distillates and residual oils, coal-tar products, natural gas and acetylene. The expression “carbon black” thus embraces notably acetylene black, channel black, furnace black, lamp black, thermal black. Acetylene black is the type of carbon black derived from the burning of acetylene. Channel black is made by impinging gas flames against steel plates or channel irons (from which the name is derived), from which the deposit is scraped at intervals. Furnace black is the term generally applied to carbon black made in a refractory-lined furnace. Lamp black, the properties of which are markedly different from other carbon blacks, is made by burning heavy oils or other carbonaceous materials in closed systems equipped with settling chambers for collecting the solids. Thermal black is produced by passing natural gas through a heated brick checkerwork where it thermally cracks to form a relatively coarse carbon black. Over 90% of all carbon black produced today is furnace black. Carbon black is available commercially from numerous suppliers such as Cabot Corporation.

Metal oxides are generally selected among Si, Zr, Zn, and Ti oxides and mixed oxide comprising these metals in combination with one or more other metal(s) or non metal(s); e.g. silica, alumina, zirconia, alumino-silicates (including natural and synthetic clays), zirconates and the like. Metal carbonates are typically selected from the group consisting of alkaline and alkaline earth metal carbonates, e.g. Ca, Mg, Ba, Sr carbonates. Metal sulphates are generally selected among alkaline and alkaline earth metal sulphates, including Ca, Mg, Ba, Sr sulphates. A metal sulphate which has provided particularly good result is barium sulphate.

Carbides suitable to be used in the composition of the present invention are generally compounds composed of carbon and a less electronegative element. Carbides can be generally classified by chemical bonding type as follows: (i) salt-like, (ii) covalent compounds, (iii) interstitial compounds, and (iv) “intermediate” transition metal carbides. Examples include calcium carbide, silicon carbide, tungsten carbide, with silicon carbide being generally preferred.

The inorganic filler is generally provided under the form of particles. As used within the frame of the present invention, the term “particle” is intended to denote a mass of material that has a definite three-dimensional volume and shape, characterized by three dimensions.

The inorganic filler particles generally have an average particles size of 0.001 μm to 1000 μm, preferably of 0.01 μm to 800 μm, more preferably of 0.01 μm to 500 μm.

To the aim of maximizing surface area and interfaces with the host polymer (A), inorganic filler particles having nanometric dimensions are typically preferred. To this aim, inorganic filler particles having an averaged particle size comprised from 1 nm to 250 nm, preferably from 5 to 200, more preferably from 10 to 150 are preferably employed.

The composition of the invention generally comprises the filler (I) in an amount of advantageously at least 1% wt, preferably of at least 2% wt, more preferably at least 3% wt, based on the weight of polymer (A).

Upper limits of filler (I) are not particularly limited, being understood that the addition of polymer (E) efficiently enables increasing concentration of filler (I) without impairing processability of polymer (A); it is nevertheless understood that compositions which have been found to provide best results are those wherein the amount of filler (I) advantageously does not exceed 50% wt, preferably does not exceed 40% wt, more preferably does not exceed 30% wt, based on the weight of polymer (A).

The amount of polymer (E) will be generally adjusted as a function of the concentration of filler (I); this amount will be comprised generally between 0.1 and 10 times the amount of filler (I), preferably between 0.15 and 5 times the amount of filler (I).

Thus, the composition of the invention generally comprises the polymer (E) in an amount of at least 0.1% wt, preferably of at least 0.2% wt, more preferably at least 0.3% wt, based on the weight of polymer (A).

While upper concentration of polymer (E) is not particularly critical, it is nevertheless understood that for avoiding impairment of mechanical properties the amount of polymer (E) in the inventive composition will be generally limited to at most 25% wt, preferably at most 20% wt, more preferably at most 15% wt, based on the weight of polymer (A).

Still another object of the invention is a process for manufacturing the composition of the invention.

Generally, the process of the invention comprises blending of the polymer (A), the filler (I) and the polymer (E).

Blending said ingredients in powder form can be advantageously comprised in the process of the invention, according to an embodiment.

To this aim, the polymer (A) to be used in the process of the invention is generally under the form of a powder having an average particle size comprised advantageously between 1 and 2500 μm, preferably between 50 and 1500 μm.

Typically, according to this embodiment, the composition of the invention can be manufactured as a powder mixture by dry blending the polymer (A), the filler (I) and the polymer (E), and, if any, all other optional ingredients, using high intensity mixers. Henschel-type mixers and ribbon mixer can be notably used.

So obtained powder mixture can comprise the polymer (A), the filler (I) and the polymer (E) in the weight ratios as above detailed, suitable for obtaining final parts, or can be a concentrated mixture to be used as masterbatch and diluted in further amounts of polymer (A) in subsequent processing steps.

It is also possible to manufacture the composition of the invention by further melt compounding the powder mixture as above described with or without an additional quantity of polymer (A).

It is generally preferred to incorporate the powder mixture as above described in an additional quantity of polymer (A).

The method for manufacturing the composition as above detailed advantageously comprises melt compounding. As said, melt compounding can be effected on the powder mixture as above detailed, or directly on polymer (A), the filler (I), the polymer (E) and, optionally any other possible ingredient.

Conventional melt compounding devices can be used. Preferably, extruders, more preferably twin screw extruders can be used.

The design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients.

According to one embodiment of the invention, the process comprises mixing polymer (A) with particles of filler (I) at least partially coated with polymer (E) as above detailed.

The Applicant thinks, without this limiting the scope of the invention, that the introduction of polymer (E) in the inventive composition under the form of coating over the particles of filler (I) enables a more controlled and progressive release of polymer (E) in the composition, thus enabling better dispersions and minimizing exudation phenomena during processing.

According to this embodiment, the process comprises a preliminary step of manufacturing inorganic filler particles at least partially coated with polymer (E). Said at least partially coated particles can be manufactured by any suitable method.

Conventional methods like impregnation or fractional precipitation of polymer (E) from a solution comprising the same by cooling or by addition of a non-solvent in the presence of particles of inorganic filler can be used.

A technique which has been found particularly appropriate is a process wherein:
polymer (E) as above detailed is solubilized in a liquid medium to obtain a solution;
particles of filler (I) are added to said solution to obtain a dispersion; and
liquid medium is separated by evaporation for recovering inorganic particles at least partially coated with polymer (E).

Liquid media which can be advantageously used are those which enable solubilising polymer (E) in reasonable conditions; among these solvents, mention can be made of (per)fluoropolyether solvents, perfluorinated ethers, perfluorinated amines. As an alternative, supercritical carbon dioxide, having outstanding solubility properties for polymer (E) can be used.

The inorganic filler particles obtained in this way are at least partially coated with polymer (E); although the so coated particles are presumed to be core/shell, such structure is merely inferred from the process by which they are made as well as from properties of the particles. It is not known, however, whether the shell layer (i.e. the coating of polymer (E)) is continuous or discontinuous, smooth or hair-like, chemically bound or merely physically surrounding it.

Experimental evidences have been nevertheless collected showing that good results have been obtained when the polymer (E) substantially completely coats the surface of the particle of the inorganic filler.

Should the disclosure of any of the patents, patent applications, and publications that are incorporated herein by reference conflict with the present description to the extent that it might render a term unclear, the present description shall take precedence.

The invention will be now described with reference to the following examples, whose purpose is merely illustrative and not intended to limit the scope of the invention.

### Raw Materials

Barium Sulphate:

Two types of chemically precipitated BaSO₄ particles, commercially available from Solvay Bario e Derivati, were used: BLANC FIXE NC50 BaSO₄ (NC50, hereinafter) possesses a surface area of 50 m²/g and BLANC FIXE HD80 (HD80, hereinafter) possesses a surface area of 2 m²/g.

Carbon Black:

the commercial Vulcan XC72 (Vulcan, hereinafter), supplied by Cabott, was used.

TFE Copolymers:

HYFLON® PFA 7000 and HYFLON® MFA F1540, commercially available from Solvay Solexis were used.

PFPE-TFE Block Copolymers:

two perfluoropolyether block copolymers manufactured according to the teachings of WO 2008/065163 (SOLVAY SOLEXIS SPA) May 6, 2008 were used; first polymer used (Polymer (E-1), herein below) was a PFPE-TFE block copolymer, characterized by a number averaged molecular weight of about 25 000 and an average of 26 —CF₂— units per block derived from TFE, and an average number of blocks derived from TFE in the copolymer of about 1.5, said block copolymer having a melting point of 230° C. Second polymer used (Polymer (E-2), herein below) was a PFPE-TFE block copolymer, characterized by a number averaged molecular weight of about 30 000 and an average of 13 —CF₂— units per block derived from TFE, and an average number of blocks derived from TFE in the copolymer of about 9.5 said block copolymer having a melting point of 130° C.

### General Procedure for the Manufacture of Coated Fillers

Block copolymer PFPE-TFE as above detailed was dissolved in GALDEN® perfluoropolyether HT55 at room temperature so as to obtain 220 g of a solution having a concentration of about 1.5% wt; the filler was then added to the polymer solution and mixed; then, the solvent was removed by evaporation in a rotating evaporator at a temperature of 85° C. under N₂ flux (5 NI/h). Weight ratios and types and amounts of block copolymer and inorganic particles are detailed in table herein below.

TABLE 1

| sample | Filler | Polymer (E) | % wt polymer (E) |
|---|---|---|---|
| IP-1 | HD-80 | E-2 | 20 |
| IP-2 | NC-50 | E-2 | 20 |
| IP-3 | Vulcan | E-2 | 30 |

### Determination of Torque and Temperature During Melt Blending

The evaluation of the torque and of the melt temperature was carried out in a measuring heated mixer (Brabender™ 50 EHT). This instrument can monitor, during a melt mixing procedure, the evolution of torque and temperature of the molten composition as a function of time. The test conditions are the following: Temperature=380° C., rotation speed=30 rpm, mixing time=420 seconds.

### EXAMPLE 1

70 g of HYFLON® PFA 7000 were mixed in a roll mill for 30 minutes with 5% w/w of the additive IP-1 and then fed into the measuring heated mixer. After 400 sec the torque and temperatures values are respectively 2 Nm and 359° C.

### EXAMPLE 2

### Comparative

70 g of HYFLON® PFA 7000 were mixed in a roll mill for 30 minutes with 5% w/w of HD80 and then fed into the measuring heated mixer. After 400 sec the torque and temperatures values are respectively 18 Nm and 372° C.

Comparison between behaviour in the heated mixer of examples 1 and 2C, carried out with same microsized inorganic filler, well demonstrates that the presence of the polymer (E), in this case introduced under the form of coating over inorganic filler particle, enables instantaneous decrease of torque values and of molten temperature.

### EXAMPLE 3

70 g of HYFLON® PFA 7000 were mixed in a roll mill for 30 minutes with 5% w/w of the additive IP-2 and then fed into the measuring heated mixer. After 400 sec the torque and temperatures values are respectively 14 Nm and 364° C.

### EXAMPLE 4

### Comparative

70 g of HYFLON® PFA 7000 were mixed in a roll mill for 30 minutes 5% w/w of NC50 and then fed into the measuring heated mixer. After 400 sec the torque and temperatures values are respectively 24 Nm and 379° C.

Comparison between behaviour in the heated mixer of examples 3 and 4C, carried out with same nanosized inorganic filler, well demonstrates that the presence of the polymer (E), also in this case introduced under the form of coating over inorganic filler particle, enables instantaneous decrease of torque values and of molten temperature, as a consequence of heating due by the shear stress.

### Extrusion Tests

The polymer HYFLON® F1540 and the additives, as specified below, were blended in a turbo-mixer for about 2 minutes. The mixed powder was fed into a twin-screw co-rotating extruder to obtain the product in the form of pellets. These pellets were then fed into a co-rotating twin-screw extruder for yielding pellets. These pellets have been used:
to mould plates having 0.3 mm thickness for evaluating flex-life behaviour according to ASTM D2176 standard (applying 90 cycles/min);
to be fed to a single screw extruder for the preparation of films for evaluation of electrical properties (Rv) according to ASTM D 257. In this case, the temperature profile in film extruder was kept fixed during in all these experiments (T1=275° C., T2=290° C., T3=300° C., T4=310° C., T5=320° C.).

The compositions tested and the results are reported in the following table:

TABLE 2

| | | | | | Flex- |
|---|---|---|---|---|---|
| | Additives | | Intensity | Rv (Ω | life |
| | (nature and | Speed | of Energy | cm−1) | (n° of |
| Test | % w/w) | (rpm) | (Amp) | *10₅ | cycles) |
| a | Vulcan (10%) | 20 | 4.0 | 1.8 | 1600 |
| (comp) | | | | | |
| b | Vulcan (10%) + | 20 | 3.2 | 0.21 | 1800 |
| | E-2 (5%) | | | | |
| c | Vulcan (10%) + | 20 | 2.9 | 0.21 | 2300 |
| | E-2 (3%) | | | | |
| d | Vulcan (10%) | 30 | failed (too | failed (too | n.a. |
| | | | high) | high) | |
| e | Vulcan (10%) + | 30 | 3.6 | 0.29 | n.a. |
| | E-2 (5%) | | | | |
| f | Vulcan (10%) + | 30 | 3.6 | 0.17 | n.a. |
| | E-2 (3%) | | | | |
| g | IP-3 (10%) | 30 | 3.9 | 1.7 | n.a. |
| h | HD80 (10%) | 25 | 4.3 | n.a. | 5600 |
| (comp) | | | | | |
| i | HD80 (10%) + | 25 | 2.4 | n.a. | 7750 |
| | 5% E-2 | | | | |
| l | HD80 (10%) + | 25 | 2.6 | n.a. | 8360 |
| | 5% E-1 | | | | |

n.a.: not available

The compounds containing the PFPE-TFE copolymers show a better processability as it is possible to operate with a lower intensity of the electrical energy (Amp) or with higher speed of rotation in comparison with the compounds that do not contain the copolymer (sample a and h). Flex life tests, carried out on films with a thickness of 0.3 mm, evidence a higher mechanical resistance for the samples containing the PFPE-TFE copolymers.

1. A thermoprocessable composition comprising:
at least one thermoprocessable per(halo)fluoropolymer [polymer (A)];
at least one inorganic filler [filler (I)]; and
at least one perfluoropolyether block copolymer [polymer (E)] comprising:
A) one or more (per)fluoropolyoxyalkylene segment (chain R_{f}) comprising recurring units having at least one catenary ether bond and at least one fluorocarbon moiety, and
B) one or more polyalkylene segment (chain Rₐ) comprising recurring units of formula: —(CR₁R₂—CR₃R₄)—
wherein R₁, R₂, R₃, R₄, equal to or different from each other, are selected from the group consisting of H, halogens; C₁-C₆ (hydro)carbon groups, optionally containing fluorine or other heteroatoms.

2. The composition of claim 1, wherein said polymer (E) complies with formula:
Tₗ-O-[A-B]_{z}-[A-B′]_{z′}-A-Tₗ′ (formula I)
wherein:
A=-(X)ₐ—O-A′-(X)_{b}—, wherein A′ is a chain R_{f}, as defined in claim 1; X, X′, equal to or different from each other, are selected from —CF₂—, —CF₂CF₂—, —CF(CF₃)—; a, b, equal to or different from each other, are integers equal to 0 or 1, wherein the block A linked to the end group Tₗ-O— has a=1 and the block A linked to the end group T′₁ has b=0;
B is a segment of recurring units derived from one or more olefins having formula:
—[(CR₁R₂—CR₃R₄)ⱼ(CR₅R₆—CR₇R₈)_{j′}]— (formula Ia),
wherein: j is an integer from 1 to 100, j′ is an integer from 0 to 100 wherein (j+j′) is higher than 2 and lower than 100; R₁, R₂, R₃, R₄, R₅, R₆, R₇, R₈, equal to or different from each other, are selected from halogen; H; C₁-C₆ groups, optionally containing F or other heteroatoms, preferably perfluoroalkyl or (per)fluorooxyalkyl, said substituents R₁-R₈ optionally containing one or more functional groups;
z is an integer higher than or equal to 2; z′ is ≧0; z, z′ are such that the number average molecular weight of the polymer (F) of formula (I) is in the range 500-500,000;
B′ is a segment otherwise complying with formula (Ia), but having at least one of the substituents R₁ to R₈ different from those in said block B;
Tₗ and Tₗ′, equal to or different from each other, are selected from H, halogen, C₁₋₃ (per)fluoroalkyls, C₁₋₆ alkyls and C₁-C₃₀ functional end groups comprising heteroatoms selected from the group consisting of O, S, and N.

3. The composition of claim 2, wherein said polymer (E) complies with formula:
Tₗ-O-[A-B]_{z}-A-Tₗ′ (formula II)
wherein:
A=-(X)ₐ—O-A′-(X)_{b}—, wherein X, a and b have the meanings defined in claim 2 and A′ is a chain R_{f} of formula:
—(CF₂CF₂O)ₐ₊(CF₂O)_{b+}(CF₂(CF₂)_{z+}CF₂O)_{c+}—,
wherein: z⁺ is 1 or 2; a+, b+, c+ are integers ≧0;
B is a segment of formula —[(CF₂—CF₂)ⱼ₊]— wherein: j+ is an integer from 2 to 100;
Tₗ and Tₗ′, equal to or different from each other, are selected from the group consisting of: —H; halogen; and C₁-C₃ perhalogenated alkyl group.

4. The composition of claim 1, wherein said polymer (A) is a homopolymer of a per(halo)fluoromonomer (PFM) or a copolymer comprising recurring units derived from more than one per(halo)fluoromonomer (PFM), wherein said per(halo)fluoromonomer (PFM) is selected from the group consisting of:
C₂-C₈ perfluoroolefins;
chloro- and/or bromo- and/or iodo-C₂-C₆ per(halo)fluoroolefins;
per(halo)fluoroalkylvinylethers complying with general formula CF₂═CFOR_{f1} wherein R_{f1} is a C₁-C₆ per(halo)fluoroalkyl;
per(halo)fluoro-oxyalkylvinylethers complying with general formula CF₂═CFOX₀₁, wherein X₀₁ is a C₁-C₁₂ per(halo)fluorooxyalkyl having one or more ether groups;
per(halo)fluoro-methoxy-alkylvinylethers complying with general formula CF₂═CFOCF₂OR_{f2} wherein R_{f2} is a C₁-C₆ per(halo)fluoroalkyl or a C₁-C₆ per(halo)fluorooxyalkyl having one or more ether groups; and
per(halo)fluorodioxoles of formula: 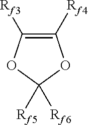
wherein each of R_{f3}, R_{f4}, R_{f5}, R_{f6}, equal to or different from each other, is independently a fluorine atom, a C₁-C₆ perfluoroalkyl group, optionally comprising one or more oxygen atom.

5. The composition of claim 4, wherein said polymer (A) is selected from the group consisting of copolymers of tetrafluoroethylene (TFE) with at least one per(halo)fluoromonomer (PFM) different from TFE.

6. The composition of claim 5, wherein said polymer (A) is selected from the group consisting of TFE copolymers comprising recurring units derived from at least one per(halo)fluoromonomer (PFM) selected from the group consisting of:
1. perfluoroalkylvinylethers complying with general formula CF₂═CFOR_{f1} wherein R_{f1} is a C₁-C₆ perfluoroalkyl;
2. perfluoro-oxyalkylvinylethers complying with general formula CF₂═CFOX₀₁, wherein X₀₁ is a C₁-C₁₂ perfluorooxyalkyl having one or more ether groups;
3. C₃-C₈ perfluoroolefins; and
4. mixtures thereof.

7. The composition of claim 5, wherein said polymer (A) is selected from the group consisting of TFE copolymers comprising recurring units derived from tetrafluoroethylene (TFE) and hexafluoropropylene (HFP) in an amount ranging from 3 to 15 wt % and, optionally, from 0.5 to 3 wt % of at least one perfluoroalkylvinylether.

8. The composition of claim 5, wherein said polymer (A) is selected from the group consisting of TFE copolymer consisting essentially of:
(a) from 3 to 13% by weight of recurring units derived from perfluoromethylvinylether;
(b) from 0 to 6% by weight of recurring units derived from one or more than one fluorinated comonomer different from said perfluoromethylvinylether and selected from the group consisting of perfluoroalkylvinylethers complying with general formula CF₂═CFOR_{f1′} wherein R_{f1′} is a C₁-C₆ perfluoroalkyl and perfluoro-oxyalkylvinylethers complying with general formula CF₂═CFOX_{01′}, wherein X_{01′} is a C₁-C₁₂ perfluorooxyalkyl having one or more ether groups;
(c) recurring units derived from tetrafluoroethylene, wherein the sum of the percentages of the recurring units (a), (b) and (c) is equal to 100% by weight.

9. The composition according to claim 1, wherein the inorganic filler is selected from the group consisting of carbonaceous materials, metal oxides, metal carbonates, metal sulphates, and carbides.

10. The composition according to claim 1, wherein the inorganic filler is provided under the form of particles having an averaged particles size of 0.001 μm to 1000 μm.

11. A process for manufacturing the composition according to claim 1 comprising the step of blending the polymer (A), the filler (I) and the polymer (E).

12. The process of claim 11 comprising the step of melt compounding said polymer (A), the filler (I) and the polymer (E).

13. The process of claim 11 comprising a preliminary step of manufacturing inorganic filler particles at least partially coated with said polymer (E), and a further step of mixing said polymer (A) with said particles of said filler (I) at least partially coated with said polymer (E).

14. The method of claim 13, wherein in said preliminary step comprises:
solubilising said polymer (E) in a liquid medium to obtain a solution;
adding said particles of said filler (I) to said solution to obtain a dispersion; and
separating said liquid medium by evaporation for recovering inorganic particles at least partially coated with said polymer (E).
